(19) United States
(12) Patent Application Publication
(10) Pub. No.: US 2025/0378135 A1
(43) Pub. Date: Dec. 11, 2025

(54) CODE CONVERSION METHOD

(71) Applicant: TDK CORPORATION, Tokyo (JP)

(72) Inventors: Kaito ASAI, Tokyo (JP); Tsuyoshi SUZUKI, Tokyo (JP)

(73) Assignee: TDK CORPORATION, Tokyo (JP)

(21) Appl. No.: 18/876,419

(22) PCT Filed: Jun. 20, 2022
(86) PCT No.: PCT/JP2022/024564

§ 371 Date: Feb. 3, 2025

(51) Int. Cl. G06F 17/18

(52) U.S. Cl. CPC G06F 17/18

(57) ABSTRACT

A code conversion method includes a conversion step of converting a first calculation model applicable to an Ising model or a QUBO in which options are represented by a first representation method into a second calculation model applicable to an Ising model or a QUBO in which options are represented by a second representation method, in which the conversion step includes solving a simultaneous equation in which each component of an energy calculated on the basis of the first calculation model matches each component of an energy calculated on the basis of the second calculation model, and obtaining a submatrix of the Hamiltonian used in computation of the second calculation model.

### TECHNICAL FIELD

The present invention relates to a code conversion method.

### BACKGROUND ART

Attempts to obtain optimum solutions of combinatorial optimization problems using quantum annealing have been made. Combinatorial optimization problems can be treated as minimization problems for obtaining combinations that minimize an arbitrary objective function.

In combinatorial optimization problems, each of a plurality of options is represented by a combination of binary variables. Known methods of representing the options include a binary representation, a one-hot representation, a domain wall representation, and a unary representation.

Patent Document 1 discloses a machine learning system that can reduce a computational load by converting bit sequences in machine learning.

### CITATION LIST

### Patent Document

Patent Document 1: Japanese Patent No. 6259946

### SUMMARY OF INVENTION

### Technical Problem

It is not difficult to change only a method of representing values corresponding to options of a combinatorial optimization problem. On the other hand, it is not easy to change a first calculation model represented in a first representation method to a second calculation model represented in a second representation method. This is because components of the Hamiltonian required for energy calculation differ depending on a difference in representation method. When the representation is changed from the first representation method to the second representation method, it is necessary to newly reconstruct the Hamiltonian from zero on the basis of the second representation method.

The present invention has been made in consideration of the above circumstances, and an object thereof is to provide a code conversion method capable of easily obtaining a submatrix of the Hamiltonian based on a second representation method by converting a submatrix of the Hamiltonian based on a first representation method.

### Solution to Problem

In order to solve the above problems, the present invention provides the following means.

A code conversion method according to a first aspect includes a conversion step of converting a first calculation model applicable to an Ising model or a QUBO in which options are represented by a first representation method into a second calculation model applicable to an Ising model or a QUBO in which options are represented by a second representation method. In the conversion step, a simultaneous equation is solved in which each component of an energy calculated on the basis of the first calculation model matches one component of an energy calculated on the basis of the second calculation model. Then, a submatrix of the Hamiltonian used in computation of the second calculation model is obtained from the solution.

In the code conversion method according to the above aspect, the submatrix of the Hamiltonian used in the computation of the second calculation model may be obtained from the following Equation (1).

$$[ Math . 1 ]$$

$${\vec{{x}_{j}^{1}}}^{T} {H}_{jk}^{1} \vec{{x}_{k}^{1}} = {\vec{{x}_{j}^{2}}}^{T} {H}_{jk}^{2} \vec{{x}_{k}^{2}} \qquad ( 1 )$$

In Equation (1), xⱼ¹ and xₖ¹ are values represented by a first representation method to which options are assigned, Hⱼₖ¹ is a submatrix of the Hamiltonian of the first calculation model, xⱼ² and xₖ² are values represented by a second representation method to which options are assigned, and Hⱼₖ² is a submatrix of the Hamiltonian of the second calculation model.

In the code conversion method according to the above aspect, the first representation method may be a binary representation, and the second representation method may be a one-hot representation.

In the code conversion method according to the above aspect, the first representation method may be a binary representation, and the second representation method may be a domain wall representation.

In the code conversion method according to the above aspect, the first representation method may be a one-hot representation, and the second representation method may be a binary representation.

In the code conversion method according to the above aspect, the first representation method may be a one-hot representation, and the second representation method may be a domain wall representation.

In the code conversion method according to the above aspect, the first representation method may be a domain wall representation, and the second representation method may be a binary representation.

In the code conversion method according to the above aspect, the first representation method may be a domain wall representation, and the second representation method may be a one-hot representation.

### Effects of the Invention

A code conversion method according to the present invention can make it possible to easily obtain a submatrix of the Hamiltonian based on a second representation method by converting a submatrix of the Hamiltonian based on a known first representation method.

### BRIEF DESCRIPTION OF DRAWINGS

FIG. 1 An image view of an Ising model and a QUBO.

FIG. 2 An example of four values represented in a one-hot representation.

FIG. 3 An example of four values represented in a binary representation.

FIG. 4 An example of four values represented in a domain wall representation.

FIG. 5 An example of four values represented in a unary representation.

FIG. 6 An example of a case where a value represented by a first representation method is represented by a second representation method again.

### DESCRIPTION OF EMBODIMENTS

The present embodiment will be described in detail below with reference to the drawings. The drawings used in the following description may show characteristic parts enlarged for the sake of clarity, and dimensional ratios and the like of each component may differ from the actual ones. Materials, dimensions, and the like exemplified in the following description are merely examples, and the present invention is not limited thereto. The present invention can be modified as appropriate without changing the gist of the present invention.

A code conversion method according to the present embodiment includes a conversion step of converting a first calculation model into a second calculation model.

The first calculation model and the second calculation model are calculation models applicable to an Ising model or a QUBO. These calculation models are used for quantum annealing. Quantum annealing is an algorithm for obtaining a minimum energy state (ground state) in accordance with a calculation model.

The Ising model is a model for predicting the overall stable state when a plurality of elements interact with each other and a forcing force is applied to each element.

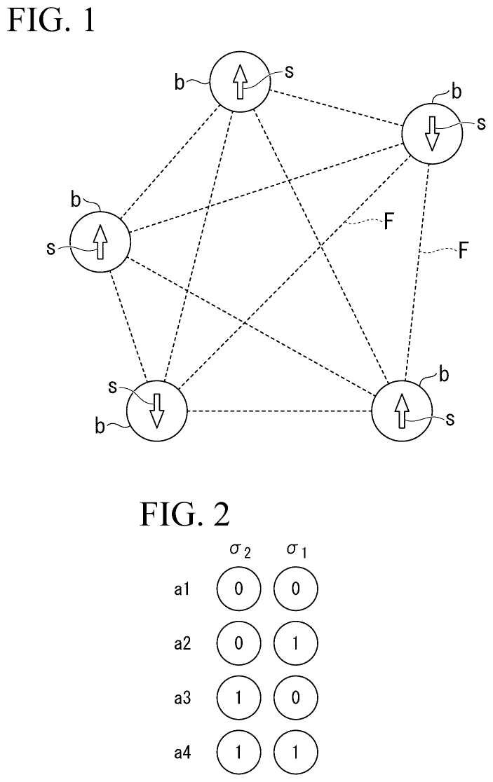

FIG. 1 is an image of an Ising model. The Ising model has a plurality of bits b that interact with each other by a forcing force F. Each of the bits b is configured with a spin s. The spin s indicates either an upward or downward state. Each of the bits b is represented by a variable that indicates a binary state. Depending on the setting of the forcing force F, a state in which adjacent spins s are parallel to each other is a stable state, or a state in which they are antiparallel to each other is a stable state. The forcing force F is referred to as an interaction parameter,

The Ising model is represented by the following energy function (cost function).

$$[ Math . 2 ]$$

$$H = {\sum }_{i \neq j} {J}_{i , j} {σ}_{i} {σ}_{j} + {\sum }_{i} {h}_{i} {σ}_{i} + α \qquad ( 2 )$$

In Equation (2), σᵢ and σⱼ are input variables. σᵢ and σⱼ are binary variables, +1 or −1. σᵢ and σⱼ correspond to the state of the spin s in FIG. 1. Jᵢⱼ is an interaction parameter. Jᵢⱼ corresponds to the forcing force F in FIG. 1. hᵢ is a parameter applied to each bit b due to an external factor, for example, a magnetic field parameter. The magnetic field parameter can be regarded as a weight related to each bit b. α is a constant.

Quadratic unconstrained binary optimization (QUBO) is a calculation model that can be converted equivalently to an Ising model. In the Ising model, each bit b is represented by a binary variable of +1 or −1, whereas in the QUBO, each bit b is represented by a binary variable of 0 or 1. Similarly to the Ising model, the QUBO is represented by a first calculation model. In the QUBO, σᵢ and σⱼ are binary variables of 0 or 1.

The Ising model and the QUBO are applicable to an integer programming problem. The integer programming problem is a problem in which each element of a solution vector is limited to integers. The Ising model and the QUBO are applicable to. for example, a combinatorial optimization problem. The combinatorial optimization problem is an example of an integer programming problem in which objects to be combined are in a discrete relationship. Examples of the combinatorial optimization problem include a traveling salesman problem, a knapsack problem, a shift optimization problem, and a delivery planning problem.

In the Ising model and the QUBO, each of a plurality of options in a combinatorial optimization problem is represented as a combination of binary variables σᵢ and σⱼ. In the case of the Ising model, the binary variables σᵢ and σⱼ are “+1” and “−1.” while in the case of the QUBO, they are “1” and “0.”

Examples of a method of representing options include a binary representation, a one-hot representation, a domain wall representation, and a unary representation.

FIG. 2 shows an example of four values a1 to a4 represented by a binary representation. Each of the values a1 to a4 is a collection of variables σᵢ. Here, a case where the number of values is four is exemplified, but the number of values is arbitrary. Options in a combinatorial optimization problem are assigned to the values a1 to a4. That is, the values a1 to a4 are values to which a plurality of options in a combinatorial optimization problem are assigned, and are values that can be taken by combinations of one or more binary variables. A method of assigning options to the values a1 to a4 is arbitrary. By assigning options to the values a1 to a4, the options correspond to the values a1 to a4. The options in the combinatorial optimization problem are represented as the values a1 to a4 in a calculation formula.

The binary representation is a method of representing N types of information in binary numbers. In the case of the binary representation, variables σᵢ respectively representing the values a1 to a4 are allowed to be “1” at the same time. The binary representation can represent a large number of states with a small number of variables σᵢ.

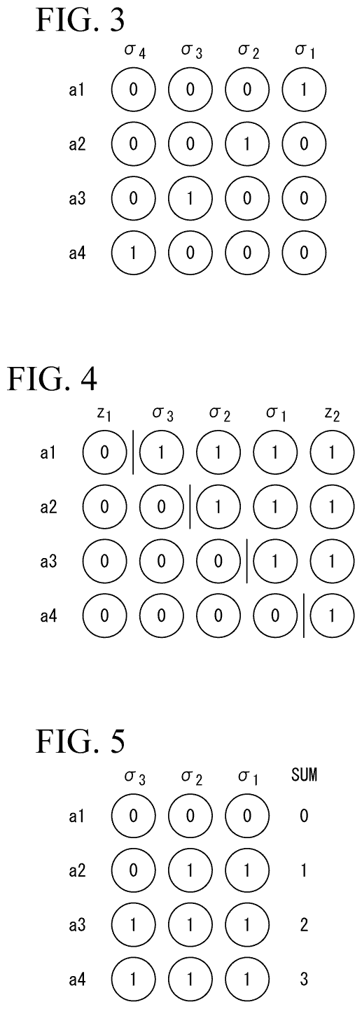

FIG. 3 shows an example of four values a1 to a4 represented by a one-hot representation. The one-hot representation is a method of representing N types of information with N variables. In the one-hot representation, N types of information may be represented by N variables or more. In the case of the one-hot representation, only one of the N variables is “1”, and the other variables are all “−1” in the case of the Ising model and all “0” in the case of the QUBO. In the one-hot representation, variables σᵢ corresponding to the number of options are required, but other states are not represented even when one of the variables σᵢ is rewritten by noise or the like, and the one-hot representation is resistant to noise.

FIG. 4 shows an example of four values a1 to a4 represented by a domain wall representation. The domain wall representation is a method of representing N types of information at the position of a boundary, and the boundary is set at a position where adjacent values are different from each other. In the case of the domain wall representation, a plurality of variables σᵢ are sandwiched between two fixed values z₁ and z₂. One fixed value z₂ is fixed to “1”, and the other fixed value z₁ is fixed to “−1” in the case of the Ising model and to “0” in the case of the QUBO.

FIG. 5 shows an example of four values a1 to a4 represented by a unitary representation. The unitary representation is a method of representing N types of information with the sum of variables.

The first calculation model is a calculation model in which options are represented using a first representation method. The first representation method is, for example, one of the above-mentioned one-hot representation, binary representation, domain wall representation, and unitary representation.

For example, the first calculation model can be represented by the following Equation (3). xⱼ¹ and xₖ¹ are values to which options are assigned and which represent the options. xⱼ¹ and xₖ¹ are represented by the first representation method. Hⱼₖ¹ is a submatrix of the Hamiltonian of the first calculation model. E¹(x) is an energy function based on the first calculation model.

$$[ Math . 3 ]$$

$${E}^{1} ( x ) = {{\sum }^{n}}_{j = 1} {{\sum }^{m}}_{k = 1} {\vec{{x}_{j}^{1}}}^{T} {H}_{jk}^{1} \vec{{x}_{k}^{1}} \qquad ( 3 )$$

For example, when n=3 and m=3, the above Equation (3) is expanded to obtain the following Equation (4).

$$[ Math . 4 ]$$

$${E}^{1} ( x ) = ( \begin{matrix}\vec{{x}_{1}^{1}} & \vec{{x}_{2}^{1}} & \vec{{x}_{3}^{1}}\end{matrix} ) ( \begin{matrix}{H}_{11}^{1} & {H}_{12}^{1} & {H}_{13}^{1} \\ {H}_{21}^{1} & {H}_{22}^{1} & {H}_{23}^{1} \\ {H}_{31}^{1} & {H}_{32}^{1} & {H}_{33}^{1}\end{matrix} ) ( \begin{matrix}\vec{{x}_{1}^{1}} \\ \vec{{x}_{2}^{1}} \\ \vec{{x}_{3}^{1}}\end{matrix} ) \qquad ( 4 )$$

Each matrix element in the above equation can be decomposed as shown in the following Equation (5).

$$[ Math . 5 ]$$

$${\vec{{x}_{1}^{1}}}^{T} {H}_{11}^{1} \vec{{x}_{1}^{1}} = ( \begin{matrix}{σ}_{1} & {σ}_{2}\end{matrix} ) ( \begin{matrix}{h}_{11}^{1} & {h}_{12}^{1} \\ {h}_{21}^{1} & {h}_{22}^{1}\end{matrix} ) ( \begin{matrix}{σ}_{1} \\ {σ}_{2}\end{matrix} ) \qquad ( 5 )$$

The above Equation (5) corresponds to a part of the energy function (cost function) of the Ising model. Equation (5) represents a local part of the energy function, and can be referred to as, for example, local energy.

The second calculation model is a calculation model in which options are represented by the second representation method. The first representation method is, for example, any of the above-mentioned binary representation, one-hot representation, domain wall representation, or unitary representation, and is a representation method different from the first representation method.

For example, the second calculation model can be represented by the following Equation (6). xⱼ² and xₖ² are values to which options are assigned and which represent the options. xⱼ² and xₖ² are represented by the second representation method. Hⱼₖ² is a submatrix of the Hamiltonian of the second calculation model. E²(x) is an energy function based on the second calculation model. Equation (6) can be expanded in the same manner as Equation (4).

$$[ Math . 6 ]$$

$${E}^{2} ( x ) = {{\sum }^{n}}_{j = 1} {{\sum }^{m}}_{k = 1} {{x}_{j}^{{2}^{′}}}^{T} {H}_{jk}^{2} {x}_{k}^{{2}^{′}} \qquad ( 6 )$$

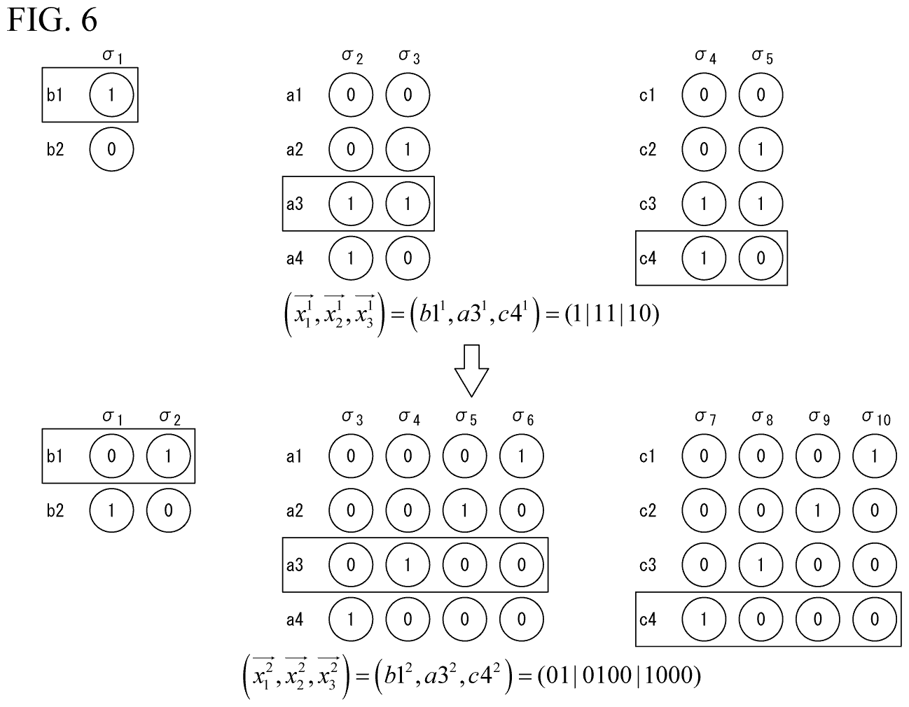

It is not difficult to represent a value, which is represented by the first representation method, by the second representation method again. FIG. 6 shows an example of a case where a value, which is represented by the first representation method, is represented by the second representation method again. FIG. 6 shows an example of a case where a first group has two options, a second group has four options, and a third group has four options. Each of the options in the first group is assigned one of values b1 and b2, each of the options in the second group is assigned one of values a1 to a4, and each of the options in the third group is assigned one of values c1 to c4.

For example, one option is selected from among the options in each of the groups, and a combination of (b1, a3, c4) is selected. When the values b1, a3, and c4 are represented by a binary representation, (1, 11, 10) can be represented as a combination of binary variables σᵢ. On the other hand, when the values b1, a3, and c4 are represented by a one-hot representation, (01, 0100, 1000) can be represented as a combination of binary variables σᵢ. In this manner, the method of representing values varies in accordance with the rule.

On the other hand, a method of converting the energy function of the first calculation model represented by Equation (3) into the energy function of the second calculation model represented by Equation (4) is not known. The correspondence between the submatrix Hⱼₖ¹ of the Hamiltonian of the first calculation model and the submatrix Hⱼₖ² of the Hamiltonian of the second calculation model is unknown, and it is difficult to linearly convert the submatrix Hⱼₖ¹ of the Hamiltonian of the first calculation model into the submatrix Hⱼₖ² of the Hamiltonian of the second calculation model.

This embodiment presents a method of obtaining the submatrix Hⱼₖ² of the Hamiltonian of the second calculation model represented by Equation (4) on the basis of results of computation using the energy function of the first calculation model represented by Equation (3).

For example, when the first calculation model is calculated using an Ising machine, a value (option, combination of values) that minimizes the energy of the energy function based on the first calculation model is obtained. This is because a value (combination of variables) represented by the first calculation model is optimized by computation using the first calculation model, and the value is determined. That is, when the first calculation model is calculated using the Ising machine, an energy represented by Equation (3) and a combination of values to which the energy is applied are obtained.

Similarly, for example, when the second calculation model is calculated using an Ising machine, a combination of values which minimizes the energy of the energy function based on the second calculation model is obtained. This is because a value (combination of variables) represented by the second calculation model is optimized by computation using the second calculation model, and the value is determined. That is, when the second calculation model is calculated using the Ising machine, an energy represented by Equation (6) and a combination of values to which the energy is applied are obtained.

As described above, it is possible to separately obtain Equation (3) and a combination of values to which Equation (3) is applied and obtain Equation (6) and a combination of values to which Equation (6) is applied. However, these computations are separate computations. That is, when the representation method is changed, it is necessary to configure a submatrix of the Hamiltonian in accordance with each of the representation methods. When it is possible to calculate the submatrix Hⱼₖ² of the Hamiltonian of the second calculation model simply by converting a representation method in accordance with a rule without newly reconstructing the submatrix of the Hamiltonian even when the representation method is converted, computation can be performed efficiently, and thus such a method is required.

Consequently, items that should not change when performing computation using the first calculation model and performing computation using the second calculation model are extracted.

One is a combination of values which minimizes the energy of the energy function. This is because an optimum solution should not be different because a value representation method is different.

The other is a magnitude relationship between energies obtained by each of the calculation models. A magnitude relationship between energies obtained by the first calculation model and a magnitude relationship between energies obtained by the second calculation model should match. For example, when an energy value (E¹(x₁)) output when a first option is selected is greater than an energy value (E¹(x₂)) output when a second option is selected in the first calculation model, an energy value (E²(X₁)) output when the first option is selected should be greater than an energy value (E²(x₂)) output when the second option is selected in the second calculation model. For example, in a traveling salesman problem, a result that the cost (time and expense) of traveling in the order of A→B→C is higher than the cost of traveling in the order of B→A→C does not change depending on the value representation method.

Consequently, in the code conversion method according to this embodiment, it is assumed that each component of the energy (E¹(x)) calculated on the basis of the first calculation model matches each component of the energy (E²(x)) calculated on the basis of the second calculation model.

Each component of the energy (E¹(x)) calculated on the basis of the first calculation model does not necessarily match each component of the energy (E²(x)) calculated on the basis of the second calculation model. However, when the assumption that each component of the energy (E¹(x)) calculated on the basis of the first calculation model matches each component of the energy (E²(x)) calculated on the basis of the second calculation model is satisfied, the condition that items that do not change when computation is performed using the first calculation model and when computation is performed using the second calculation model do not change is satisfied. Thus, even when the above assumption is made, an energy function calculated on the basis of the second calculation model should not be inappropriate.

When the above assumption is satisfied, the following Equation (1) is established.

$$[ Math . 7 ]$$

$${\vec{{x}_{j}^{1}}}^{T} {H}_{jk}^{1} \vec{{x}_{k}^{1}} = {\vec{{x}_{j}^{2}}}^{T} {H}_{jk}^{2} \vec{{x}_{k}^{2}} \qquad ( 1 )$$

Here, as described above, when the first calculation model is calculated, xⱼ¹, xₖ¹, and Hⱼₖ¹ are obtained. In addition, since a combination of values for deriving an optimum solution must not change, xⱼ² and xₖ² satisfy xⱼ¹=xⱼ² and xₖ¹=xₖ². That is, the only unknown in Equation (1) is the submatrix Hⱼₖ² of the Hamiltonian. Thus, by solving the simultaneous equations obtained by expanding Equation (1), the submatrix Hⱼₖ² of the Hamiltonian can be obtained.

As a specific example, an example in which the submatrix Hⱼₖ² of the

Hamiltonian is obtained, for example, when j=k=3 is shown. It is assumed that x¹ represents four options by a binary representation. x¹ can be represented as x₁¹=0,0), x₂¹=(1,0), x₃¹=(0,1), and x₄¹=(1,1). In addition, it is assumed that x² represents four options by a one-hot representation. x² can be represented as x₂¹=(1,0,0,0), x₂²=(0,1,0,0), x₃¹=(0,0,1,0), and x₄¹=(0,0,0,1).

In addition, it is assumed that H₁₁¹ and H₁₁² have the following relationship.

$$[ Math . 8 ]$$

$${H}_{11}^{1} = ( \begin{matrix}{h}_{11}^{1} & {h}_{12}^{1} \\ {h}_{21}^{1} & {h}_{22}^{1}\end{matrix} ) \qquad ( 7 )$$

$${H}_{11}^{2} = ( \begin{matrix}{h}_{11}^{2} & {h}_{12}^{2} & {h}_{13}^{2} & {h}_{14}^{2} \\ {h}_{21}^{2} & {h}_{22}^{2} & {h}_{23}^{2} & {h}_{24}^{2} \\ {h}_{31}^{2} & {h}_{32}^{2} & {h}_{33}^{2} & {h}_{34}^{2} \\ {h}_{41}^{2} & {h}_{42}^{2} & {h}_{43}^{2} & {h}_{44}^{2}\end{matrix} )$$

When calculation is performed on the basis of the above relationship, the following Equation (8) is established.

$$[ Math . 9 ]$$

$${H}_{11}^{2} = ( \begin{matrix}{h}_{11}^{2} & {h}_{12}^{2} & {h}_{13}^{2} & {h}_{14}^{2} \\ {h}_{21}^{2} & {h}_{22}^{2} & {h}_{23}^{2} & {h}_{24}^{2} \\ {h}_{31}^{2} & {h}_{32}^{2} & {h}_{33}^{2} & {h}_{34}^{2} \\ {h}_{41}^{2} & {h}_{42}^{2} & {h}_{43}^{2} & {h}_{44}^{2}\end{matrix} ) = ( \begin{matrix}0 & 0 & 0 & 0 \\ 0 & {h}_{11}^{1} & {h}_{12}^{1} & {h}_{11}^{1} + {h}_{12}^{1} \\ 0 & {h}_{21}^{1} & {h}_{22}^{1} & {h}_{21}^{1} + {h}_{22}^{1} \\ 0 & {h}_{11}^{1} + {h}_{12}^{1} & {h}_{21}^{1} + {h}_{22}^{1} & {h}_{11}^{1} + {h}_{12}^{1} + {h}_{21}^{1} + {h}_{22}^{1}\end{matrix} ) \qquad ( 8 )$$

By performing the above-described calculation on each of j=1 to 3 and k=1 to 3 of Hⱼₖ², the submatrix Hⱼₖ² of the Hamiltonian can be obtained.

As described above, in the code conversion method according to this embodiment, it is not necessary to reconstruct a calculation model using a changed representation method even when the representation method is changed. The code conversion method according to this embodiment uses a calculation model by a specific representation method that has already been calculated to convert a calculation model obtained by changing a representation method in accordance with a rule, and thus the code conversion method is excellent in computational efficiency. For this reason, the code conversion method according to this embodiment can easily change the value representation method in accordance with a required application.

When the code conversion method according to this embodiment is used, a representation method for a calculation model can be changed, for example, from a binary representation to a one-hot representation, a domain wall representation, or a unary representation.

In addition, when the code conversion method according to this embodiment is used, a representation method for a calculation model can be changed, for example, from a one-hot representation to any of a binary representation, a domain wall representation, and a unary representation.

When the code conversion method according to this embodiment is used, a representation method for a calculation model can be changed, for example, from a domain wall representation to a binary representation, a one-hot representation, or a unitary representation.

In addition, when the code conversion method according to this embodiment is used, a representation method for a calculation model can be changed, for example, from a unitary representation to a binary representation, a one-hot representation, or a domain wall representation.

Here, as an example, conversion between a binary representation, a one-hot representation, a domain wall representation, and a unitary representation is presented. but a convertible representation method is not limited thereto.

This calculation model is applicable to, for example, an Ising machine that specializes in the calculation of an Ising model and a QUBO. The calculation model is stored in an Ising machine, for example, as a calculation program. The calculation program gives instructions to a processor and causes the processor to perform processing according to the calculation model. Machines such as a quantum annealing machine (D-wave, NEC), a coherent Ising machine (NTT), a simulated bifurcation machine (Toshiba), a digital annealer (Fujitsu), and a CMOS annealer (Hitachi) are examples of the Ising machine.

The Ising machine may be a quantum gate type computer. For example, the Ising model and the QUBO can be calculated by a quantum gate type computer by using a quantum approximate optimization algorithm (QAOA).

Although the embodiment of the present invention has been described above in detail with reference to the drawings, the configurations, combinations thereof, and the like in each embodiment are merely examples, and addition, omission, substitution, and other modifications of the configurations can be made without departing from the spirit of the present invention.

### REFERENCE SIGNS LIST

b Bit
s Spin
F Forcing force

1. A code conversion method comprising a conversion step of converting a first calculation model applicable to an Ising model or a QUBO in which options are represented by a first representation method into a second calculation model applicable to an Ising model or a QUBO in which options are represented by a second representation method,
wherein the conversion step includes solving a simultaneous equation in which each component of an energy calculated on the basis of the first calculation model matches each component of an energy calculated on the basis of the second calculation model, and obtaining a submatrix of the Hamiltonian used in computation of the second calculation model.

2. The code conversion method according to claim 1, wherein
the submatrix of the Hamiltonian used in the computation of the second calculation model is obtained from the following Equation (1):
$$[ Math . 1 ]$$
$${\vec{{x}_{j}^{1}}}^{T} {H}_{jk}^{1} \vec{{x}_{k}^{1}} = {\vec{{x}_{j}^{2}}}^{T} {H}_{jk}^{2} \vec{{x}_{k}^{2}} \qquad ( 1 )$$
in Equation (1), xⱼ¹ and xₖ¹ are values represented by a first representation method to which options are assigned, Hⱼₖ¹ is a submatrix of the Hamiltonian of the first calculation model, xⱼ² and xₖ² are values represented by a second representation method to which options are assigned, and Hⱼₖ² is a submatrix of the Hamiltonian of the second calculation model.

3. The code conversion method according to claim 1, wherein
the first representation method is a binary representation, and
the second representation method is a one-hot representation.

4. The code conversion method according to claim 1, wherein
the first representation method is a binary representation, and
the second representation method is a domain wall representation.

5. The code conversion method according to claim 1, wherein
the first representation method is a one-hot representation, and
the second representation method is a binary representation.

6. The code conversion method according to claim 1, wherein
the first representation method is a one-hot representation, and
the second representation method is a domain wall representation.

7. The code conversion method according to claim 1, wherein
the first representation method is a domain wall representation, and
the second representation method is a binary representation.

8. The code conversion method according to claim 1, wherein
the first representation method is a domain wall representation, and
the second representation method is a one-hot representation.
